(19) United States
(12) Patent Application Publication
(10) Pub. No.: US 2015/0352732 A1
(43) Pub. Date: Dec. 10, 2015

(54) Protective weapon

(71) Applicants: Jeffrey C. Levine, North Potomac, MD (US); Joshua D. Levine, North Potomac, MD (US); Evan M. Levine, North Potomac, MD (US)

(72) Inventors: Jeffrey C. Levine, North Potomac, MD (US); Joshua D. Levine, North Potomac, MD (US); Evan M. Levine, North Potomac, MD (US)

(21) Appl. No.: 14/120,552

(22) Filed: Jun. 4, 2014

(51) Int. Cl. B26B 1/08; F41B 13/00

(52) U.S. Cl. CPC B26B 1/08; F41B 13/00

(57) ABSTRACT

A self-defense weapon for women and others, comprising a lightweight, portable single or multi-bladed weapon adapted to be held in the hand and when activated by squeezing, one or more blades are exposed outwardly between the fingers. When the hand is relaxed, the weapon is deactivated, and the blades retract into the body of the weapon (sheath) protecting the user, so the weapon may be safely carried in the user's pocket or purse.

### STATEMENT OF INVENTION

This invention generally relates to portable self-defense weapons for women and others, and is particularly concerned with a single or multi-bladed weapon that is easily and rapidly employed to fend off an attacker.

### BACKGROUND

Animals and birds have sharp claws to both attack and defend against predatory animals for survival. Without these natural assets, women need a similar artificial weapon to fend off predators.

In the past many non-conventional knives and blades have been proposed for different purposes that are carried or supported by the human hand, with many being used for cutting, scraping, tearing, or penetrating.

For example, multiple fixed bladed weapons attached to handles, in which the blades are continuously exposed, have been available for many years. In another example, a multi-bladed weapon is disclosed in U.S. Pat. No. (U.S. 4,096,629 A) whereby the blades are not continuously exposed, but stored in the handle, and activated by a mechanical mechanism to project and retract the blades back into the handle upon operation by the user.

SUMMARY OF THE INVENTION

The present invention provides for a small, portable, lightweight, easy to use single or multi-bladed weapon that can be carried and safely stored by the user, yet rapidly activated when needed to repel an assault. Unlike earlier patents, the blade or blades are fixed length and not moveable, and a retractable protective means normally isolates the blades in the body of the weapon to protect the user when not activated. To activate, the user squeezes the weapon, the retractable protective spring means constricts, and exposes the fixed length blade or blades for use against an attacker. When the user relaxes their grip, the retractable protective spring means expands to again sheathe the blade or blades in the body of the weapon and protect the user from the blades.

This weapon may be similar in appearance and function to animal claws or talons, or pointed cutting blades, and used the same way animals do to repel attacks, or may be a penetrative blade for use against predators. This single or multi-bladed weapon is hand held, lightweight, portable and when squeezed, constricts the compressible spring means resulting in the cutting or stabbing end of the blades protruding between and beyond the users fingers, and used in a “cutting, slashing or penetrating” action as the blades are applied against the body of the attacker. Although no special skills, training, or strength is required on the part of the user, the device is highly effective.

In preferred embodiments, the blade or blades are small, spaced apart in parallel according to the width of the fingers, and normally contained or sheathed within the retractable protective spring means and rigid upper member designed to sheathe the blades, guide the blades during use, and provide structural rigidity. This retractable protective spring means automatically expands when the weapon is not in use, to sheathe the blade or blades and safely carry the device in the hand, pocket, or purse, without danger to the user. In use, the person squeezes the weapon, which constricts the retractable protective spring means, exposing the cuffing or penetrating edges of the blades. This weapon is designed to be small, portable, lightweight, easy to use and functional for defense when needed. Unlike earlier patents, the blades are fixed length, movable only with respect to the users hand, and only exposed for use when the user squeezes the retractable protective spring means to expose the blade or blades, as a claw or penetrating weapon.

This weapon may have a strap means attached to the rigid upper portion, rigid lower portion or both, that fastens around the outside of the users hand and is expandable to fit most users hands. The strap means may be expandable material or two separate straps attachable by attachment means such as snaps, Velcro, or other materials. The strap means will prevent the user from inadvertently dropping the weapon or having it removed by the attacker during use.

### BRIEF DESCRIPTION OF THE DRAWINGS

FIG. 1 is a perspective view of the preferred embodiment when the weapon is in a relaxed mode and not in use;

FIG. 2 is a perspective view of the preferred embodiment when the weapon is compressed and ready for use;

FIG. 3 is a cross sectional view of FIG. 2 when the weapon is compressed and ready for use;

FIG. 4 is a cross sectional view of FIG. 3, when compressed by the human hand, with blades exposed and ready for use;

FIG. 5 is an exploded view of the component parts of the weapon prior to assembly.

### DETAILED DESCRIPTION OF PREFERRED EMBODIMENT

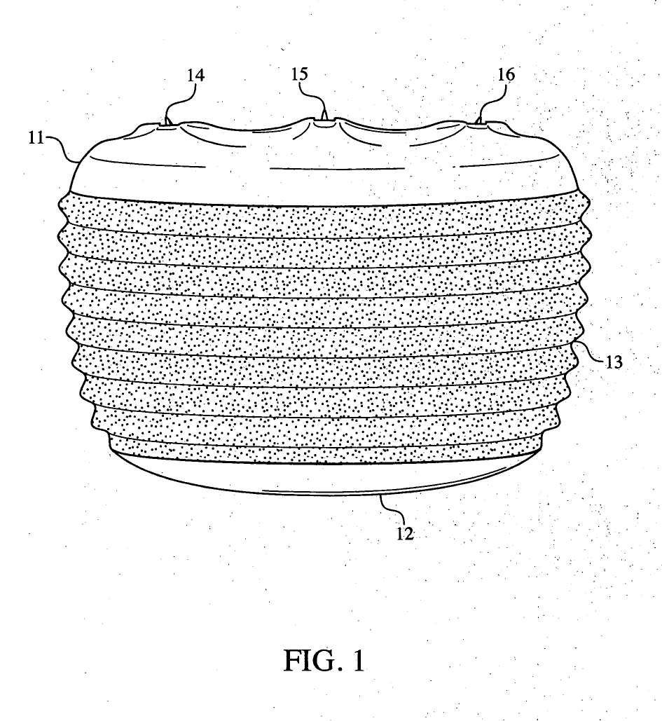

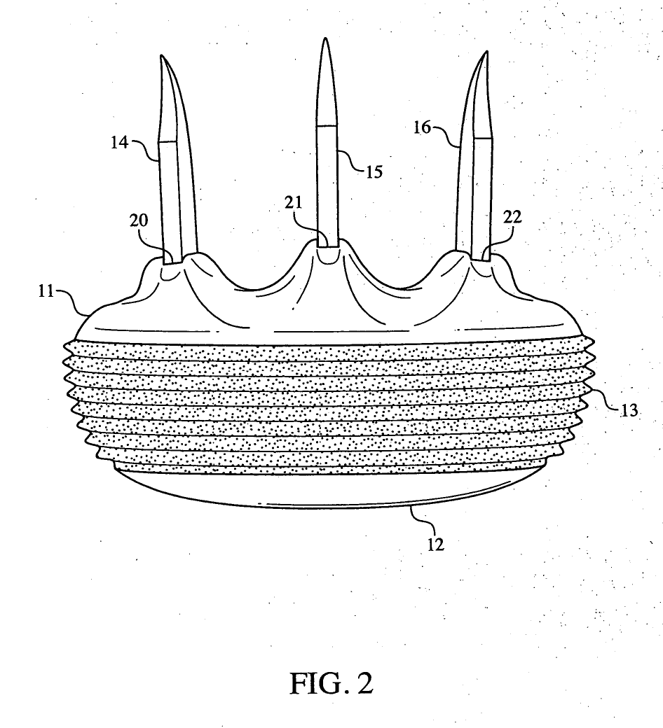

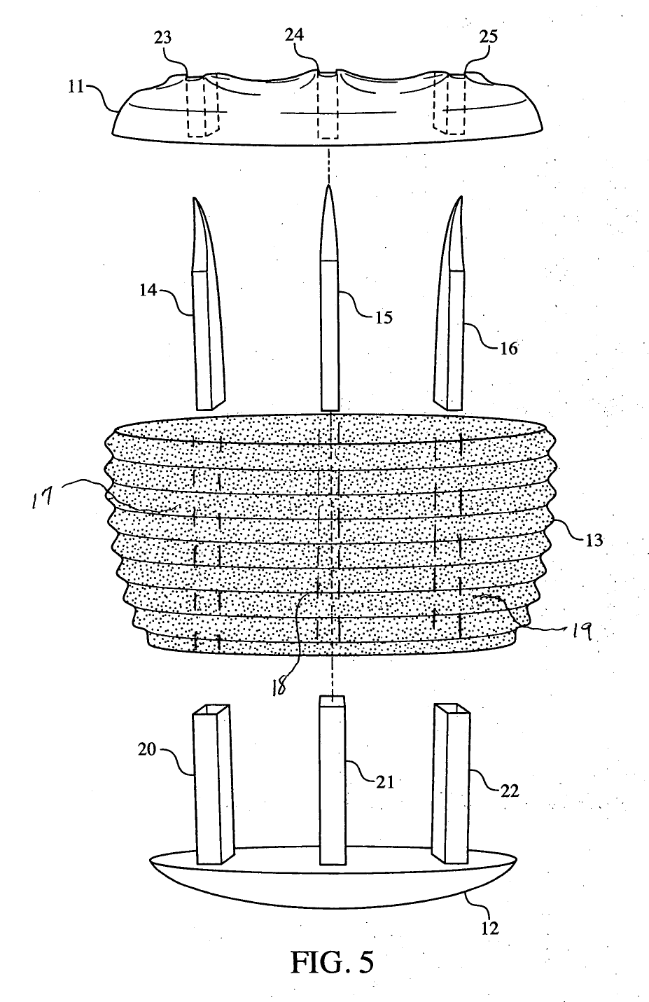

Referring to FIG. 1, the weapon's handle/sheath comprises a rigid upper member 11, and a rigid lower member 12, interconnected together by flexible compressible spring means such as semi-rigid material 13. This material may be foam, sponge, rubber or foam plastic material, or other compressible material that is flexible and has sufficient resistance to expand when not in use. One or more of a series of blades 14, 15, and 16 are spaced equidistant apart by the width of the human finger, and fixedly attached to the rigid lower member 12, or aligned slots in lower member FIGS. 5, 20, 21, and 22 and project in a perpendicular manner away from the rigid lower member 12. The blades 14, 15, and 16 are adapted (as shown in FIG. 5), to pass through a series of aligned slots in the flexible spring means 17, 18, and 19. The rigid upper member 11, also has aligned slots (FIGS. 2) 23, 24, and 25, through which the blades 14, 15, and 16 are also adapted to pass through when the weapon is squeezed to expose the blades as shown in FIG. 2. The blades, 14, 15, and 16, project vertically away from the rigid lower member 12, and when not in use, the blades 14, 15, and 16 are enclosed within the retractable protective spring means 13, as shown in FIG. 1, and rigid upper member 11, for safe storage when the weapon is not activated.

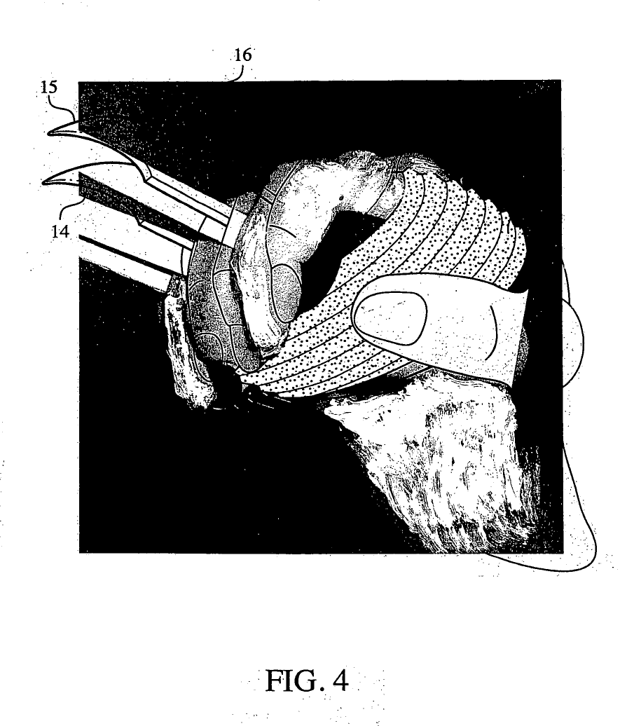

In operation, when the hand is clenched as shown in FIG. 4, and the retractable protective means 13, squeezed, the blades 14, 15, and 16 pass through both the slots of the retractable protective means 17, 18, and 19 and slots of the rigid upper member 23, 24, and 25 as shown in FIG. 5, and between and beyond the users fingers. The weapon is then activated and ready for use.

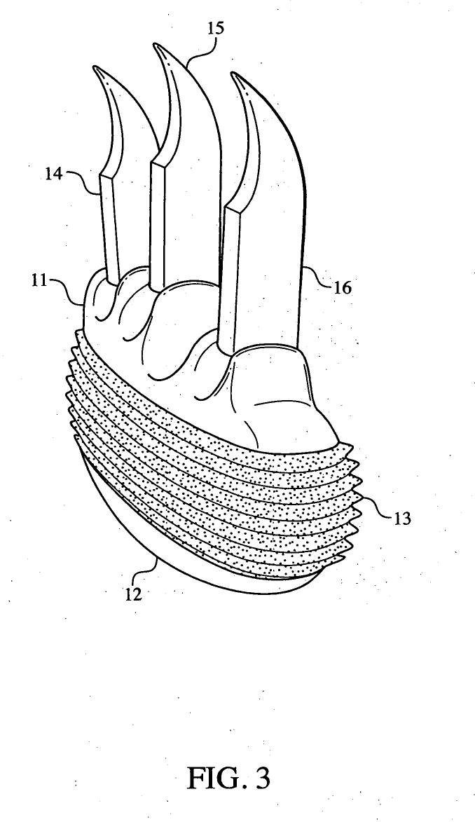

This weapon has been designed to be small, portable, lightweight, and effective; resulting in a highly functional piece of equipment, as shown in FIGS. 1 through 4.

Although not intended or designed as a lethal weapon, the shape/configuration of the blade or blades 14, 15, and 16 may be varied, to provide a sharp claw-like blade, a flat sharp bladed edge, a serrated edge, a sharp conical point, or other cutting edge as desired. The materials used may also be varied including metals, plastics, springs, sponges or other materials for the blades and holder/sheath and other elements shown and described. The rigid upper member 11 may contain indolations or finger guides between the rigid upper member slots 23, 24, and 25 to prevent the blade or blades 14, 15, and 16 from coming in contact with the fingers when the weapon is squeezed. In addition, the rigid upper member, 11, may contain suitable external markers/guides (not shown in drawings) to inform the user to hold the weapon with the cutting edges of the blades 14, 15 and 16 pointed toward the attacker and away from the user.

The handheld weapon may also include (not shown in drawings) a strap means attached to the rigid upper portion, rigid lower portion or both, that fastens around the outside of the users hand and is expandable to fit most users hands. The strap means may be expandable material or two separate straps attachable by attachment means such as snaps, Velcro, or other materials. The strap means will prevent the user from inadvertently dropping the weapon during use.

### Method of Manufacture

In the preferred embodiment both the rigid upper member and rigid lower member are molded using high impact plastic or other sufficiently rigid material to effectively perform as a defensive weapon. The rigid upper member and rigid lower are assembled together to be interfitted with one another for reciprocal movement of a blade or blades into and through openings in the flexible spring means and openings in the rigid upper member, and a sponge or other material with sufficient resistance to interconnect the rigid upper and rigid lower members, is attached to both the rigid upper member and rigid lower member with glue or other epoxy, and expandable to separate the rigid upper member from the rigid lower member and sheathe the blade when not in use.

Since these and many other changes may be made without departing from the spirit and scope of this invention, this invention should be considered as being limited only by the following claims.

What is claimed is:

1. An artificial weapon comprising:
A handle/sheath means comprising a rigid upper member and rigid lower member, and a retractable/flexible spring means interconnecting both member for relative movement (expansion and contraction) toward and away from each other, having at least one blade rigidly supported by the rigid lower member, said blade having a pointed edge at one end adapted for cutting or piercing when the weapon is activated, with the entire weapon adapted to be held within the fist of the users hand, and when the handle/sheath is squeezed to compress the flexible spring means, the blade projects through both the retractable protective spring means and rigid upper member, and outward between and beyond the fingers to expose the cutting/piercing edge portion of the blade, and as the hand relaxes, the retractable protective spring means automatically expands, and the blade retracts into the protective spring means and rigid upper portion to sheathe the blade and protect the user from injury.

2. In the weapon of claim 1, a plurality of spaced apart blades rigidly supported by the rigid lower member, said blades having a pointed edge at one end adapted for cutting or piercing when the weapon is activated, with the entire weapon adapted to be held in the fist of the users hand, and when the handle/sheath is squeezed to compress the flexible spring means, said blades project through both the retractable protective spring means and rigid upper member, and outward between and beyond the fingers to expose the cutting/piercing edge portion of the blades.

3. A handle/sheath means comprising a rigid upper member and rigid lower member, and a retractable/flexible spring means interconnecting both portions for relative movement (expansion and contraction) toward and away from each other, having at least one blade guided by said upper and lower members, said blade having a pointed edge at one end adapted for cutting or piercing when the weapon is activated, with the entire weapon adapted to be held within the fist of the users hand, and when the handle/sheath is squeezed to compress the flexible spring means, the blade projects through both the retractable protective spring means and rigid upper member, and outward between and beyond the fingers to expose the cutting/piercing edge portion of the blade, and as the hand relaxes, the retractable protective spring means automatically expands, and the blade retracts into the protective spring means and rigid upper portion to sheathe the blade and protect the user from injury.

4. In the weapon of claim 3, a plurality of blades spaced apart by the width of the human finger and positioned between the rigid upper member and rigid lower member, and guided by the two members, said blades having a pointed edge at one end adapted for cutting or piercing when the weapon is activated, with the entire weapon adapted to be held within the fist of the users hand, whereby when the handle/sheath is squeezed to compress the flexible spring means, said blades are guided by the upper and lower members, and project through both the retractable protective spring means and rigid upper member, and outward between and beyond the fingers to expose the cutting/piercing edge portions of the blades, and as the hand relaxes, the retractable protective spring means automatically expands, and the blades retract into the protective spring means and rigid upper portion to sheathe the blades and protect the user from injury.

5. An artificial weapon having a series of blades within a handle sheath means comprising a rigid upper member and retractable protective spring means having slots to receive and guide the cutting portion of a plurality of blades between the fingers of the human hand, as well as isolate the users fingers which are spaced apart according to the width of a human finger from the cutting portion of the blades during constriction and retraction of the weapon, thereby avoiding injury to the user.

6. An artificial weapon having a handle/sheath adapted to be substantially enclosed within the fist of a human hand, comprising a rigid upper portion, a rigid lower portion and retractable protective spring means interconnecting the two portions for moving the upper portion with respect to the lower portion. There is also a plurality of cutting or stabbing blades connected to the rigid lower portion, and spaced equidistantly apart from one another by the width of a human finger. When the weapon is compressed by squeezing the hand, the blades project away from the rigid lower portion through slots in both the retractable protective spring means and the rigid upper portion and outward between and beyond the fingers to expose the cutting or stabbing blades, and when the hand relaxes, the flexible spring means expands and the cutting edge blades retract into the rigid upper portion and flexible spring means to house the blades and protect the user during storage and transport of the weapon.

7. In the weapon of claim 6, said rigid upper member and rigid lower member of the weapon comprising separate parts, and said retractable protective spring means comprising spring means connecting the two parts.

8. An artificial weapon designed to be held within a human hand, including a handle/sheath, comprising a rigid upper member and rigid lower member moveable with respect to each other, and a retractable protective spring means interconnecting both portions for relative movement, including a plurality of blade means attached to the rigid lower member with cutting and stabbing edges, spaced equidistantly apart by the width of a human finger, with said blade means being normally enclosed within the rigid upper portion and retractable protective spring means when the weapon Is relaxed, and when compressed, the blade means extend through slots in both the retractable protective means and the rigid upper portion: and outward between and beyond the fingers to expose the cutting edge portion of the blades.

9. In the weapon of claim 8, said retractable protective means comprising spring like, resilient flexible material that is readily compressible by the human hand, but with sufficient resistance to automatically expand when not in use.

10. An artificial weapon designed to be substantially entirely enclosed within a human hand and comprised of a rigid lower portion having at least one blade rigidly attached to the lower portion with a cutting edge at one end, adapted for movement between the human fingers, and an attached retractable protective spring means that is compressible and expandable, supported by the base member. When not compressed, said blade is isolated from the user by the retractable protective spring means and rigid upper portion, and when compressed the cutting edge of the blade projects through slots in both the flexible spring means and rigid upper portion, and between and beyond the fingers for use, said retractable protective spring means being self-expandable from its compressed state when the hand of the user is relaxed.

11. A self-defense weapon for use by women and others to repel an attacker, said weapon being portable, and when activated resembling an artificial weapon, whereby said weapon is configured to be hand held and having a plurality of blades equidistantly spaced apart by the width of the human finger, whereby said weapon having guide means to assist the user in proper handling of the weapon and ensure the cutting portion of the blade or blades are facing away from the user and in the direction of the attacker, with said weapon having retractable protective spring means for normally isolating the blades from the user within the body of the weapon for safety when the weapon is not activated, and said weapon being squeezable by the user to constrict the retractable protective spring means and expose the blade or blades when activated to confront the attacker.

12. In the weapon of claim 11, said handheld weapon may have a strap means attached to the rigid upper portion, rigid lower portion or both, that stretches around or fastens around the outside of the users hand and is expandable to fit most users hands. The strap means may be expandable material or two separate straps attachable by attachment means such as snaps, Velcro, or other materials. The strap means will prevent the user from inadvertently dropping the weapon during use.

13. A self defense weapon adapted to be held within a users hand, said weapon having at least one cutting blade that is normally isolated from the users hand when the weapon is not activated and wherein the weapon is adapted to be activated by squeezing the users hand into a fist to project said cutting blade outwardly between the fingers of the users hand and deactivated to retract said cutting blade when relaxing the users fist.

14. A self defense weapon having a rigid lower member for contact within the users palm, a rigid upper member to sheathe the cutting blade when not in use, guide the cutting blades when in use and provide structural rigidity, and a flexible compressible means interconnecting said rigid lower member and rigid upper member, whereby when the weapon is activated by squeezing, the cutting blade is projected outwardly beyond the rigid upper member, and between the users fingers, and when relaxed, the cutting blade is retracted to rest inside the rigid upper member and flexible compressible means.

15. A method of making a self-defense weapon adapted to be contained within the fist of a users hand, and having at least one blade that is activated by squeezing ones fist, with the blade projecting beyond the rigid upper member and between the users fingers, and when relaxed the blade retracts into the body of the weapon.

16. In the method of claim 14, the forming of the upper and lower members being performed by molding each unit from a hardenable plastic, with the rigid upper member integrally formed with a blade opening and the rigid lower member and blade molded as one unit.

17. In the method of claim 14, said upper and lower members being assembled in a reciprocally moveable manner whereby when the user squeezes the weapon, the flexible compressible material is compressed to expose the blade outwardly between the users fingers.
